(19) United States
(12) Patent Application Publication
(10) Pub. No.: US 2016/0217421 A1
(43) Pub. Date: Jul. 28, 2016

(54) REMOTE MANAGEMENT TECHNIQUES

(71) Applicant: NCR Corporation, Duluth, GA (US)

(72) Inventors: Steven J. Giera, Dacula, GA (US); John DeSetto, Cumming, GA (US); Joel A. Miller, Sandy Springs, GA (US)

(21) Appl. No.: 14/606,097

(22) Filed: Jan. 27, 2015

(51) Int. Cl. G06Q 10/10

(52) U.S. Cl. CPC G06Q 10/103

(57) ABSTRACT

Remote management techniques which allow existing workflows to remain intact and manager responses to workflow tasks to be completed on or off-site using a mobile communication device, such as a smartphone or tablet. An example remote management method includes receiving a workflow task from a local management system by a workflow management system, sending a message by the workflow management system to a mobile communication device carried by a manager requesting that the manager respond to the workflow task, receiving a manager response from the mobile communication device by the workflow management system, and providing the manager response to the local management system by the workflow management system.

### BACKGROUND

The present invention relates to local management system 20s, such as point of sale (POS) systems, and more specifically to remote management techniques.

Some local laws require that certain operational or workflow tasks at retail store sites be performed by the manager of the location. These requirements are easily satisfied when the manager is on-site at the POS system. But when the manager is not on-site or immediately available at the POS system, these requirements are not so easily satisfied. A retailer may omit or automate certain operational tasks that require manager response, but may still be required to perform other tasks that require manager response.

One example requirement includes manager approval of price changes at a site. However, when a retailer, such as one that sells fuel, wants to open a location that will remain unstaffed during operation, this requirement may be difficult to satisfy.

Other example requirements may include manager approval/disapprovals of age-restricted items, item/transaction voids, and price overrides and voids.

Therefore, it would be desirable to provide remote management techniques which facilitate remote performance of required workflows by managers.

### SUMMARY

In accordance with the teachings of the present invention, remote management techniques are provided.

An example remote management method includes receiving a workflow task from a local management system by a workflow management system, sending a message by the workflow management system to a mobile communication device carried by a manager requesting that the manager respond to the workflow task, receiving a manager response from the mobile communication device by the workflow management system, and providing the manager response to the local management system by the workflow management system.

Configuring a local management system to route processing of workflow tasks to a manager's mobile communication device allows the manager to be anywhere, including on or off-site. For unattended installations, the manager may be remote to the site and still be able to complete workflow tasks from the local management system.

The example remote management method may further include logging the workflow task in a record associated with the local management system by the workflow management system. The workflow management system may have many such records associated with different local management systems.

The example remote management method may further include periodically checking the record and sending out a reminder message to the mobile communication device by the workflow management system when the workflow task is not marked as completed.

In the example method, the mobile communication device may execute a mobile application which receives the message from the workflow management system, records a manager response, and sends the manager response to the workflow management system.

An example remote management system includes a workflow management system configured to receive a workflow task from a local management system, send a message to a mobile communication device carried by a manager requesting that the manager respond to the workflow task, receive a manager response from the mobile communication device, and provide the manager response to the local management system.

These remote management techniques also facilitate completion of workflows with minimal changes to local management systems. Existing workflows can remain intact and only require the added capability of exporting workflow information and requests to the workflow management system and receiving responses from the workflow management system as alternatives to displaying requests to, and capturing responses from, on-site managers. Manager approvals may be easily added to transactions as if the managers were on-site.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 is a block diagram of an example site management system; and

FIG. 2 is a flow diagram illustrating an example remote management method.

### DETAILED DESCRIPTION

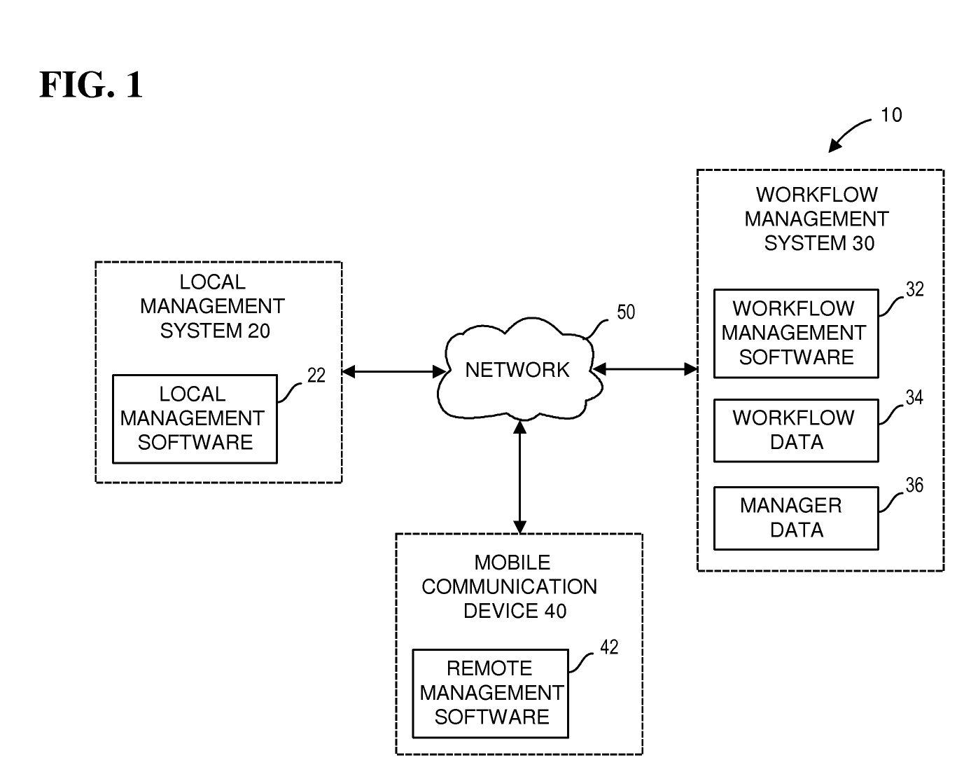

With reference to FIG. 1, an example site management system 10 includes local management system 20, workflow management system 30, and mobile communication device 40 connected by network 50. Site management system 10 may include multiple sites, each with its own local management system 20.

Local management system 20 includes one or more processors, memory, and program and data storage. Local management system 20 may include any combination of site and cloud-based systems. Local management system 20 may execute an operating system, such as a Microsoft, Google, Apple, or Linux operating system. Local management system 20 further includes network circuitry for connecting to network 50, via wire and/or wireless, and other circuitry for connecting to one or more peripherals, such as an input device and display (e.g., a touch overlay to the display). For example, local management system 20 may include Universal Serial Bus (USB) circuitry and/or Bluetooth standard circuitry.

Local management system 20 may include, but not be limited to, a personal computer, a portable computer, or a mobile computing/communication device, such as a smart phone, tablet, or personal digital assistant. For example, local management system 20 may include a retail point-of-sale (POS) computer. Local management system 20 may be associated with a site that has or does not have human operators. For example, local management system 20 may be associated with an unattended fuel filling station.

Local management system 20 executes other computer software that may be stored in a computer readable medium. For example, local management system 20 executes local management software 22, which may include one or more software applications that perform transaction functions related to the sale of goods or services and local store management functions at a site.

Local management software 22 is also equipped to communicate with workflow management system 30 via network 50. Local management software 22 sends messages containing workflow tasks that require a manager's attention to workflow management system 30.

Workflow tasks may include various types of tasks that require manager decision. For example, workflow tasks include tasks required by law. As another example, workflow tasks include tasks that provide accountability for managers to address maintenance, training, and other issues at local sites. For example, local management system 20 may determine that there is a potential failure or malfunction of a piece of hardware. As another example, local management system 20 may determine that a cashier or other employee's performance requires correction or training. Local management system 20 may generate a workflow task describing the issue for resolution by the relevant manager. For transient issues, local management system 20 may automatically withdraw the task. In the context of a filling station, examples transient issues may include a pump with low fuel flow rate, a pump that is offline, or a cashier that is ringing up excessive voids.

In any of these cases, a workflow task remains outstanding until acknowledged by a responding manager or the workflow task is no longer relevant. Workflow tasks that are no longer relevant are available for review, but are not cluttering the assigned manager's workflow.

In one example embodiment, local management software 22 may send the workflow tasks in real time as they occur. In another example embodiment, local management software 22 may periodically send the workflow tasks in batch as a list.

Local management software 22 also receives responses to task notification messages associated with workflow tasks from workflow management system 30. In one example embodiment, local management software 22 polls workflow management system 30 to determine whether workflow management system 30 has received responses, and if so, retrieve them. In another example embodiment, local management software 22 receives the responses in messages addressed to local management system 20. Local management software 22 then processes the response to complete the workflow.

Workflow management system 30 includes one or more processors, memory, and program storage, and may execute an operating system such as a Microsoft or Linux operating system. Workflow management system 30 further includes network circuitry for connecting to network 50, and may include other circuitry for connecting to peripherals. The functions of workflow management system 30 may be provided by one or more cloud-based computers.

The processor executes software which is stored in a computer readable medium, such as a memory. For example, workflow management system 30 executes workflow management software 32 which maintains workflow data 34 containing records of workflow tasks organized by each local management system 20. Workflow data 34 includes workflow tasks that are open or awaiting responses and workflow tasks that have been completed.

Each site is assigned a unique site identifier that must be provided with any tasks sent by local management systems 20 to workflow management system 30. Once a workflow task is created, local management software 22 tags the task with the unique site identifier so that workflow management software 32 knows where to route a response when workflow management software 32 receives the response.

Workflow management software 32 receives workflow tasks from local management systems 20 and sends task notification messages requesting responses to mobile communication devices 40 of responsible managers. Workflow management software 32 also sends manager responses to local management systems 20.

Workflow management system 30 is configured with a list of managers and a mapping of the sites they are responsible for as manager data 36. A single site can have multiple managers.

Manager data 36 further includes contact information for sending task notification messages to mobile communication devices 40. Contact information may include phone numbers and email addresses and task notification messages may be sent as voice, text, email or other types of messages.

Task notification messages go to all designated mobile communication devices 40 of designated managers. After one manager provides a response, workflow management software 32 automatically sends updates to all manager devices 40.

Workflow management software 32 logs the workflow tasks in workflow data 34, receives responses to task notification messages from mobile communication devices 40, and marks corresponding workflow tasks in workflow data 34 as completed. Workflow management software 32 annotates the tasks with responses, who provided them and when they were received, for accountability.

Workflow management software 32 also periodically determines task notification messages that have not been answered after a predetermined time period. In such instances, workflow management system 30 sends follow-up requests for responses to mobile communication devices 40 of corresponding managers.

Workflow management software 32 makes the responses available to corresponding local management systems 20. In one example embodiment, local management system 20 polls workflow management system 30 using the unique site identifier to determine whether workflow management system 30 has received responses, and if so, retrieve them. In another example embodiment, workflow management software 32 may send the response to local management system 20 using the unique site identifier.

Mobile communication device 40 may include a smart phone, personal digital assistant, or other portable communication device carried by a manager. Mobile communication device 40 may include one or more processors, memory, program storage, a display, an input device (which may be combined with the display as a touch screen, and cellular and network communication circuitry. Mobile communication device 40 may execute an operating system such as a Microsoft, Google, or Apple operating system.

The processor executes software which is stored in a computer readable medium, such as a memory. For example, mobile communication device 40 executes remote management software 42 which receives task notification messages requesting responses to workflow tasks and messages containing task resolutions, as appropriate, from workflow management system 30. In one example embodiment, remote management software 42 causes mobile communication device 40 to display or sound an alert when the message is received. After the manager enters a response, remote management software 42 sends the response to workflow management system 30. Remote management software 42 may include a mobile application written to be executed within the operating system of mobile communication device 40.

Advantageously, configuring local management system 20 to route processing of workflow tasks to mobile communication device 40 allows the manager to be anywhere, including on or off-site. For unattended installations, the manager may be remote to the site and still be able to complete workflow tasks from local management system 20.

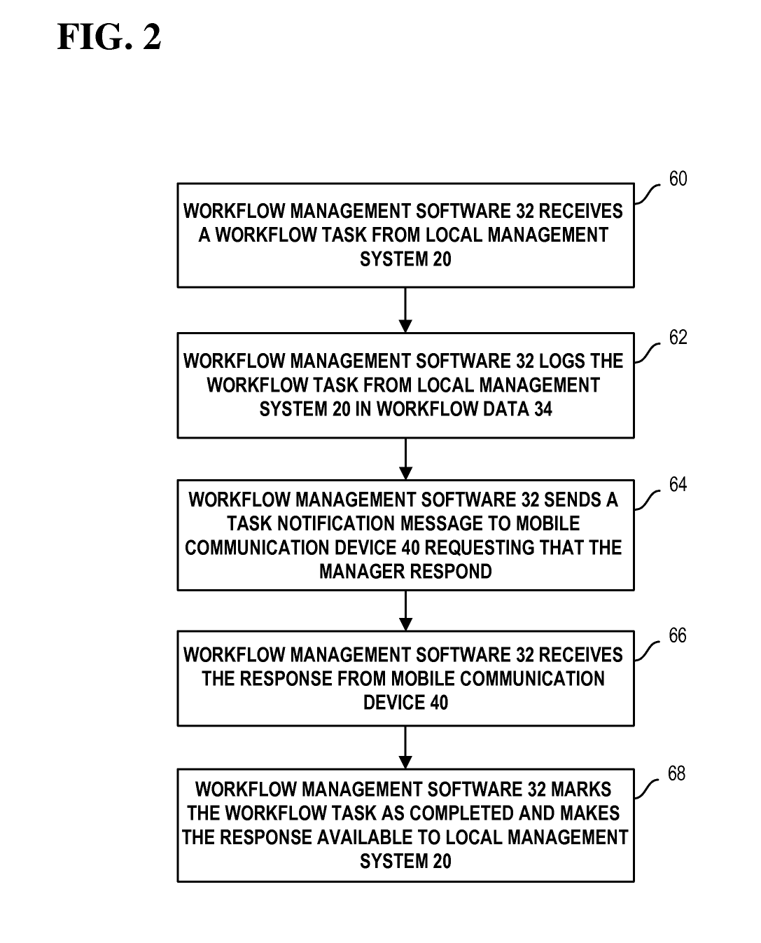

Referring now to FIG. 2, an example remote management method is illustrated in the context of a filling station and transactions involving the sale of fuel and possibly other items.

In step 60, workflow management software 32 receives a message containing a workflow task from local management system 20. The message contains the unique site identifier associated with the site and local management system 20.

For example, the workflow task may be a request from local management system 20 to authorize a change in the retail price of fuel at the filling station.

In step 62, workflow management software 32 logs the workflow task from local management system 20 in workflow data 34. Workflow management software 32 also assigns a unique task identifier to each task.

In step 64, workflow management software 32 sends a task notification message to mobile communication device 40 containing the unique task identifier and requesting that one or more managers respond to the task notification message.

Workflow management software 32 determines managers and corresponding contact information from manager data 36. Task notification messages go to all designated mobile communication devices 40 of designated managers.

In one example, the request may be to approve or deny a price change.

Workflow management software 32 periodically determines task notification messages that have not been answered after a predetermined time period. In an example embodiment, workflow management software 32 periodically checks workflow data 34 for uncompleted tasks and sends out reminders to managers that have not responded in a timely fashion.

The designated manager uses remote management software 42 to enter a response to the task notification message.

In step 66, workflow management software 32 receives a message containing the response from mobile communication device 40.

The response message also contains the unique task identifier so that workflow management software 32 can store and process the response. Workflow management software 32 annotates the task in workflow data 34 with the response, who provided it and when it was responded to, for accountability.

After one manager provides a response to a task, workflow management software 32 may automatically send update messages to all manager devices 40, when multiple managers are designated to respond.

In step 68, workflow management software 32 marks the workflow task as completed in workflow data 34 and makes the response available to local management system 20.

In one example embodiment, local management system 20 polls workflow management system 30 using the unique site identifier to determine whether workflow management system 30 has received responses, and if so, retrieve them. In another example embodiment, workflow management software 32 may send the response to local management system 20 using the unique site identifier.

After receiving the response, local management system 20 processes the response to complete the workflow.

In the example case of price changes at a fuel filling station, local management system 20 must update a local database recording the price change. Based on this update, updated configuration files will be provided to the forecourt (pump) controller. The forecourt controller will update any connected price signs and pumps with the new price (in a specific order based on legal requirements).

As described above, the task response could be to a manager override request (age verification, price change or void). In this case, local management system 20 would receive the task response from workflow management system 30 and add the manager's approval to the transaction, allowing the cashier to proceed with the transaction.

As described above, the task response could be a maintenance or training task. In this case, local management system 20 would record the manager's response to the resolution, e.g., scheduled replacement of pump fuel filters to improve fuel flow rate.

Advantageously, these remote management techniques facilitate completion of workflows with minimal changes to local management systems 20. Existing workflows can remain intact and only require the added capability of exporting workflow information and requests to workflow management system 30 and receiving responses from workflow management system 30 as alternatives to displaying requests to, and capturing responses from, on-site managers. Manager approvals may be easily added to transactions as if the managers were on-site.

Although the invention has been described with particular reference to certain preferred embodiments thereof, variations and modifications of the present invention can be effected within the spirit and scope of the following claims.

What is claimed is:

1. A remote management method comprising:
receiving a workflow task from a local management system by a workflow management system;
sending a message by the workflow management system to a mobile communication device carried by a manager requesting that the manager respond to the workflow task;
receiving a manager response from the mobile communication device by the workflow management system; and
providing the manager response to the local management system by the workflow management system.

2. The method of claim 1, further comprising:
logging the workflow task in a record associated with the local management system by the workflow management system.

3. The method of claim 2, further comprising:
marking the workflow task in the record as completed by the workflow management system after receipt of the manager response.

4. The method of claim 2, further comprising:
periodically checking the record by the workflow management system to determine whether the workflow task is marked as completed.

5. The method of claim 4, further comprising:
sending out a reminder message to the mobile communication device by the workflow management system when the workflow task is not marked as completed.

6. The method of claim 1, wherein making comprises:
sending the manager response to the local management system by the workflow management system.

7. The method of claim 1, wherein making comprises:
storing the manager response in the record by the workflow management system; and
facilitating local management system access to the record by the workflow management system.

8. The method of claim 1, wherein making comprises:
storing the manager response in the record by the workflow management system;
receiving a polling message from the local management system by the workflow management system; and
responding to the polling message by the workflow management system with the manager response from the record.

9. The method of claim 1, wherein sending comprises:
sending the message to a mobile application of the mobile communication device.

10. The method of claim 1, wherein receiving a manager response comprises:
receiving the response from a mobile application of the mobile communication device.

11. The method of claim 1, wherein the local management system is configured to operate with the manager located remotely from the site.

12. The method of claim 1, wherein the workflow task comprises a price change authorization request.

13. A remote management method comprising:
receiving a workflow task from a local management system by a workflow management system;
storing the workflow task in a record associated with the local management system by the workflow management system;
sending a message by the workflow management system to a mobile application of a mobile communication device carried by a manager requesting that the manager respond to the workflow task;
receiving a manager response from the mobile application of the mobile communication device by the workflow management system;
marking the workflow task in the record as completed by the workflow management system; and
providing the manager response to the local management system by the workflow management system.

14. A remote management system comprising:
a workflow management system configured to receive a workflow task from a local management system;
send a message to a mobile communication device carried by a manager requesting that the manager respond to the workflow task;
receive a manager response from the mobile communication device; and
provide the manager response to the local management system.

15. The remote management system further comprising:
a data store containing a record associated with the local management system containing the workflow task and the manager response.
